(19) United States
(12) Patent Application Publication
(10) Pub. No.: US 2007/0095742 A1
(43) Pub. Date: May 3, 2007

(54) Disc filtration system with improved backwashing

(76) Inventor: Rodney Ruskin, San Rafael, CA (US)

Correspondence Address: CHRISTIE, PARKER & HALE, LLP, PO BOX 7068, PASADENA, CA, 91109-7068, US

(21) Appl. No.: 11/588,149

(22) Filed: Oct. 25, 2006

Related U.S. Application Data
(60) Provisional application No. 60/732,568, filed on Nov. 1, 2005.

(51) Int. Cl. B01D 29/00

(52) U.S. Cl. 210/333.01; 210/506; 210/411; 210/108; 210/330; 210/791

(57) ABSTRACT

A disc filtration system comprises a filter element containing microporous plastic discs through which liquid effluent such as wastewater is passed for filtration. The filter disc surface material contains an anti-bacterial agent exposed to the liquid being filtered for inhibiting growth of microorganisms on the exterior of the filter element. The exposure to the anti-bacterial agent inhibits microorganism growth to an extent that prolongs the useful operational filtration cycle life of the filter between backwashing cycles. The invention applies to disc filters having automatic backwashing and manually operated disc-type filters.

### CROSS REFERENCE TO RELATED APPLICATION

This non-provisional application claims priority to U.S. Provisional Application No. 60/732,568, filed Nov. 1, 2005.

### FIELD OF THE INVENTION

This invention relates to disc filtration systems, and more particularly, to use of an anti-bacterial agent for inhibiting growth of microorganisms on the exterior of a filter element.

### BACKGROUND

Disc filtration experiences a severe problem when biologically active fluids are being filtered. The biological growth sticks the discs together. The surface area of the disc can be both large and grooved, so the force required to separate the discs for cleaning can be substantial.

Automatically backwashed filters use a technique of removing the clamping pressure on the discs during the backwash cycle. One example of such automatically backwashed disc filtration systems is the “Spin Klin” filter sold by Arkal Filtration Systems of Jordan Valley, Israel. When backwashing such filters, all the discs do not separate and the automatic backwash is inefficient due to build up of biological growth on the disc. The number of discs stuck together increases over time and eventually the filter has to be disassembled for cleaning. Different filter manufacturers use different variations of this method, and all suffer the same problem.

In the case of manual disc filters, a common operating procedure is to backwash the discs by reversing the flow until this becomes ineffective due to the adhesion of the biological growth in the grooves in the discs. The filter is then taken apart for cleaning.

### SUMMARY OF THE INVENTION

The present invention has to do with disc filters used for the filtration of fluids containing biologically active materials. The invention is characterized by the addition of an anti-bacterial agent to the discs of the disc filtration system, to inhibit growth of biological material such as organic matter or other material containing microorganisms which would tend to grow on and adhere to the surface of the disc. The invention improves the separation of the discs during automatic backwashing and extends the time of effective operation with manual filters which are backwashed without separating the discs.

One embodiment of the invention comprises a disc for use in a filter for filtering liquids such as wastewater or other liquids containing biologically active materials. The disc has a face forming at least a portion of a flow path through which liquid to be filtered passes. At least a portion of the disc is made from a polymeric material which is exposed to the flow path of liquid being filtered. This polymeric material portion of the disc contains an anti-bacterial agent which is exposed to the flow path and contained in the disc material at a level sufficient to inhibit biological growth on the disc surface caused by microorganisms contained in the liquid to be filtered. The inhibited biological growth on the disc results in extending the effective operation time of the filter disc between backwashing cycles when compared to a similar filtration system having the same polymeric disc but absent the anti-bacterial agent.

Embodiments of the filtration disc comprise a flat grooved plastic ring having a profile useful in trapping organic contaminants in the wastewater. The filtration disc can be the type contained in a filter assembly containing multiple discs compressed together and disposed in an automatically backwashed filter. The filter disc also can be contained in a manual filter having a reverse flow cycle for backwashing, for example.

The anti-bacterial agent can comprise a bacteriostat, bactericide, disinfectant, germicide or fungicide, or any other such anti-bacterial agent that can be dispersed in or molded into the disc material or disposed on a contact surface of the disc sufficiently to maintain a level of effectiveness in preventing or inhibiting biological growth on the disc when the disc is contacted by the liquid being filtered.

Embodiments of the disc include the anti-bacterial agent embedded in the plastic disc material or applied to the active face of the disc as a coating containing the anti-bacterial agent.

The disc filter of this invention can be used in filtration systems for filtering various effluents which may have a biological growth problem, including wastewater; potable water; primary, secondary and/or tertiary treated effluent in a water treatment plant; lake or river water; industrial effluent, including chemical or petrochemical plant effluent; cooling towers; and ground surface water or sea water, for example.

These and other aspects of the invention will be more fully understood by referring to the following detailed description and the accompanying drawings.

### DRAWINGS

FIG. 1 is a fragmentary, semi-schematic perspective view showing a pair of adjacent grooved filtration discs for use in a disc filtration system in which the discs contain an anti-bacterial agent according to principles of this invention.

FIG. 2 is a semi-schematic side elevational view illustrating one of several types of filtration systems in which the invention can be used.

### DETAILED DESCRIPTION

Disc filtration generally is often involved in the filtration of various fluids containing biologically active materials. The present invention provides improvements in disc filtration systems adapted for filtering liquid effluent containing various types of biologically active materials. These biologically active materials can be present in wastewater, potable water, treated effluent in a water treatment plant, industrial effluent such as chemical or petrochemical plant effluent, effluent in the mining industry or food processing industry, cooling towers, lake or river water, and ground surface water or sea water, for example. These and other liquids containing biologically active materials which are filtered according to principles of this invention are referred to herein as “effluent containing biologically active materials.”

As mentioned previously, disc filters generally, which are involved in filtering effluent containing various types of biologically active materials, experience undue biological growth on the discs or other components of the disc filtration system which can interfere with the normal process of backwashing the filter.

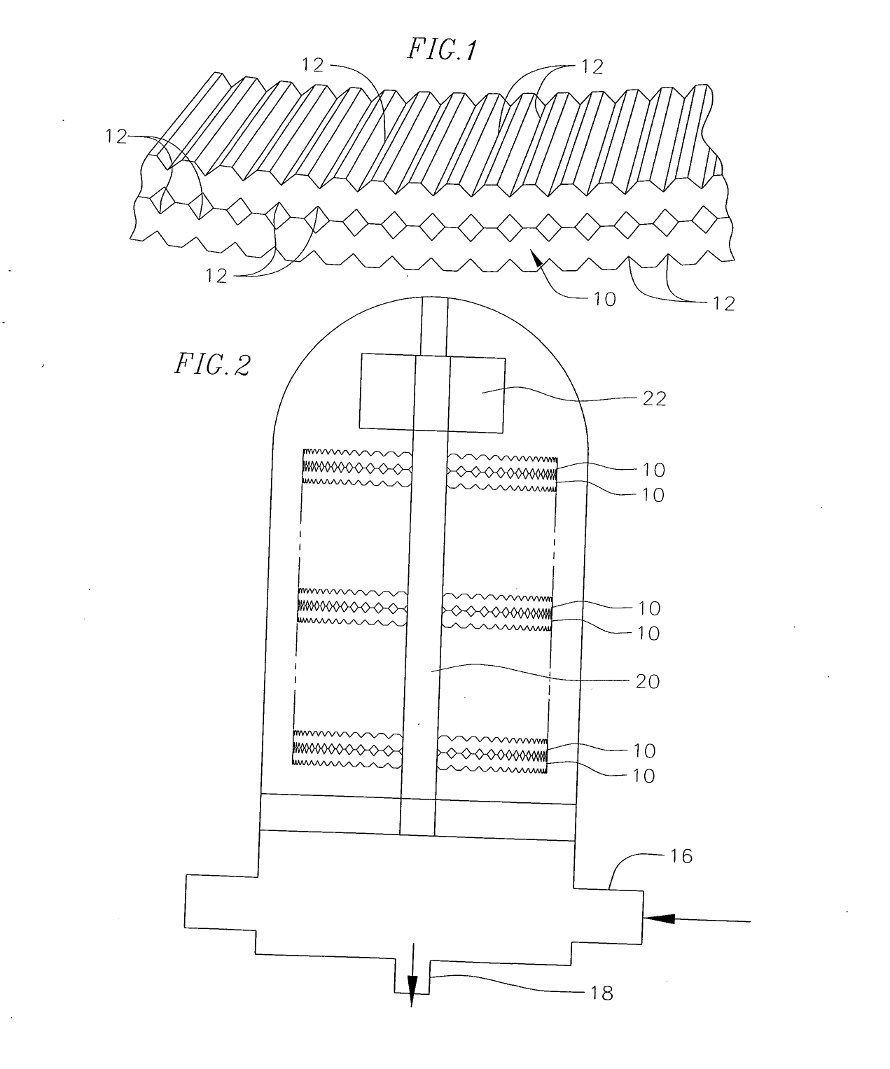

The invention comprises the addition of an anti-bacterial agent to the discs. FIG. 1 illustrates an example of filtration discs 10 with which the invention can be used. In the illustrated example the discs have grooved surfaces 12 on both sides, as described in more detail below. This, however, is one example, since the invention also can be used with filtration discs with substantially flat upper and lower surfaces, or other profiled surfaces. The anti-bacterial agent is present in or on the disc 10 at a level sufficient to inhibit the growth rate or essentially prevent the growth of biological material on the disc, at least to the extent that the normal cycle time between backwashing of the filtration discs is extended. The anti-bacterial agent may comprise a bacteriostat, bactericide, disinfectant, germicide, or fungicide, for example. This anti-bacterial agent (represented schematically at 14) can be incorporated into the disc such as by dispersing it in the plastic molding compound from which the disc, or at least a portion of the disc, is made. Commercially available compounds of arsenic (e.g. 10, 10′-oxybisphenoxarsine (OBPA)), tin (e.g. tri-n-butyl tin maleate), silver (e.g. silver sodium hydrogen zirconium phosphate) and diiodomethyl-p-tolyl sulfone are examples of materials which may be effective. In one embodiment, the anti-bacterial agent is selected from one or more compounds of arsenic, tin, silver and/or sulfone compounds. During use, the anti-bacterial agent is released from the polymeric disc or surface material at a rate that produces a filtrate that is essentially non-toxic to humans.

Although the present invention is useful in inhibiting biological growth in the discs of filters used in disc filtration systems generally, the invention is particularly useful in automatically backwashed filters. The following description relates to an automatically backwashed disc filtration system sold by Arkal Filtration Systems under the designation “Spin Klin” which is an example of the type of disc filtration system in which the invention can be used.

In the Arkal automatically backwashed disc filtration system, the discs are flat, grooved plastic rings with a hole in the center. FIG. 2 illustrates the Arkal filter generally which includes a corrosion- and pressure-resistant housing 15 which contains the filtration discs 10. During use, wastewater of the various types described previously, and which may contain biologically active materials, enter the filtration apparatus at 16, passing through the filtration system as described below, after which the filtered liquid exits the filtration apparatus at 18.

The exterior surfaces of the discs 10 are diagonally grooved at 12 on both sides to a specific micron size. A series of these discs are stacked and compressed on an elongated cylindrical spine 20. When stacked, the groove on top runs opposite to the groove below, creating a filtration element with a statistically significant series of valleys and traps for solids. As effluent to be filtered is pressurized into the filter, it compresses the rings tightly together. The grooves in the rings criss-cross, forming a network that traps both organic and inorganic contaminants from the effluent source. Filtered liquid exits from the inside of the cylinder at 18.

The spine assembly has a spring compression unit 22 which includes an internal piston. The compression unit operates during alternate filtering or backwashing modes. During the filtration process, the filtration discs are tightly compressed together by the spring's force and the differential pressure. (The spring and the pressure difference compress the discs tightly during the filtration process, forcing the water (i.e., the material being filtered) to flow between the grooves and the traps of the stacked discs.) Filtration occurs while water is percolating from the peripheral end to the core of the filter element. During operation when filtering liquids containing biologically active materials, biological growth adheres to the grooves in the discs.

Disc filters, either automatic or manual, can be cleaned manually by removing the cover of the filter housing, manually separating the discs, and spraying the filter element with clean water. Backflush models (semi-automatic or fully automatic) reverse the flow, forcing clean water from the inside of the disc filter element outward through the grooves, for cleaning the filter. Extreme conditions and/or very fine filtration of effluent requires backwashing with a combination of water and pneumatic pressurized air.

During backwashing, pressure drop build up and/or time cycle initiate a pulse transmitted by a controller to a backflushing valve, causing backflow of filtered liquid (or inflow of clean liquid from outside source, with or without pneumatic air). The direction of backflushing is opposite to that of regular filtration flow. After a short delay, a drain valve is opened to create a high pressure differential in the backflushing direction. The withdrawal of the tightening cylinder relieves the pressure from the discs and they loosen and are free to spin. Spinning is caused by an inflating sleeve which feeds the spray nozzles through which tangential jets are emitted. The jets cause the discs to spin at high speed. The retained solid particles are washed outward, and contaminated liquid flows out to a waste or recycling basin. At the end of the backwash cycle, the filtration element is compressed again, allowing another filtration cycle to begin.

Biological growth which adheres to the grooves in the discs can cause the discs to stick together which can prevent the discs from separating or otherwise interfere with the previously described automatic backwashing process.

The presence of the anti-bacterial agent in or on the disc surface can prevent or inhibit such biological growth, which improves separation of the discs, resulting in more efficient operation during the automatic backwash cycles.

The invention has similar applicability to manually operated disc filters.

What is claimed is:

1. A disc for use in a filter for filtering liquid effluent containing biologically active materials, the disc having a face forming at least a portion of a flow path through which liquid to be filtered passes, the disc face made from a polymeric material adapted for exposure to the flow path of filtered liquid, the polymeric material containing an anti-bacterial agent adapted for exposure to the flow path and contained in or on the disc at a level sufficient to inhibit biological growth on the disc caused by microorganisms contained in the filtered liquid so as to extend the effective operation time of the filter disc between backwashing cycles when compared with a similar polymeric disc absent the anti-bacterial agent.

2. Apparatus according to claim 1 in which the disc comprises a grooved polymeric filter element having a profile useful in trapping contaminants in the liquid effluent, and in which the anti-bacterial agent is exposed to the grooved portion of the disc.

3. Apparatus according to claim 1 in which the disc is contained in a filter assembly containing multiple such discs compressible together and disposed in an automatically backwashing filter.

4. Apparatus according to claim 1 in which the filter disc is contained in a manual filter having a reverse flow cycle for backwashing.

5. Apparatus according to claim 1 in which the anti-bacterial agent is embedded in the polymeric disc material or applied to an active face of the disc as a coating containing the anti-bacterial agent.

6. Apparatus according to claim 5 in which the polymeric material comprises a thermoplastic material.

7. Apparatus according to claim 1 in which the anti-bacterial agent is selected from the group comprising arsenic, tin, silver and/or sulfone compounds.

8. Apparatus according to claim 1 in which the anti-bacterial agent is releasable from the polymeric disc material at a rate that produces a filtered liquid or filtrate which is essentially non-toxic to humans.

9. A disc filtration system comprising a filtration chamber, one or more discs for filtering liquids input to the filtration chamber, in which liquid entering the chamber passes through the discs to filter the liquid and provide filtered liquid to an outlet of the chamber, said one or more discs adapted for filtering liquid effluent containing a biologically active material, said disc comprising a polymeric microporous filter element adapted to contact the liquid to be filtered, and an anti-bacterial agent contained in or on at least a portion of the filter element and adapted to contact the liquid to be filtered, the anti-bacterial agent being present in or on the filter element at a concentration level sufficient to inhibit the growth rate or prevent the growth of biological material on the surface of the filter element from microorganisms contained in the liquid passing through or in contact with the disc.

10. Apparatus according to claim 9 in which said concentration level produces a filtered liquid or filtrate which is essentially non-toxic to humans.

11. Apparatus according to claim 9 in which the disc comprises a grooved plastic filter element having a profile useful in trapping contaminants in the liquid effluent.

12. Apparatus according to claim 9 in which the filter disc is contained in a filter assembly containing multiple discs compressible together and disposed in an automatically backwashing filter.

13. Apparatus according to claim 9 in which the filter disc is contained in a manual filter having a reverse flow cycle for backwashing.

14. Apparatus according to claim 9 in which the anti-bacterial agent is embedded in the polymeric disc material or applied to an active face of the disc as a coating containing the anti-bacterial agent.

15. Apparatus according to claim 9 in which the anti-bacterial agent is selected from the group comprising arsenic, tin, silver and/or sulfone compounds.

16. A process for filtering a liquid effluent containing a biologically active material comprising:
providing a filter apparatus containing one or more filtration discs through which liquid effluent to be filtered passes for removing filtered material from the liquid passing through or into contact with the filtration apparatus,
the filtration disc comprising of polymeric microporous filter element adapted to contact the liquid to be filtered, and an anti-bacterial agent contained in or on a portion of the filter element and adapted to contact the liquid to be filtered, the anti-bacterial agent being present in or on the filter element at a concentration level sufficient to inhibit the growth rate or prevent the growth of biological material on the surface of the filter element, and
passing the liquid to be filtered through the filter element containing the anti-bacterial agent to an outlet portion of the filter.

17. The process according to claim 16 in which the disc comprises a grooved plastic filter element having a profile useful in trapping contaminants in the liquid to be filtered.

18. The process according to claim 16 in which the filter disc is contained in a filter assembly containing multiple discs compressible together and disposed in an automatically backwashing filter.

19. The process according to claim 16 in which the anti-bacterial agent comprises any one or a blend of a bacteriostat, bactericide, disinfectant, germicide or fungicide.

20. The process according to claim 16 in which the disc is adapted for use in a filtration system in which liquid effluent to be filtered comprises wastewater; potable water; primary, secondary and/or tertiary treated effluent in a water treatment plant; lake or river water; industrial effluent, including chemical or petrochemical plant effluent; effluent from a food processing plant; cooling towers; and ground surface water or sea water.
